(19) United States
(12) Patent Application Publication
(10) Pub. No.: US 2005/0017968 A1
(43) Pub. Date: Jan. 27, 2005

(54) Differential stream of point samples for real-time 3D video

(76) Inventors: Stephan Wurmlin, Zurich (CH); Markus Gross, Uster (CH); Edouard Lamboray, Zurich (CH)

Correspondence Address: Patent Department;Mitsubishi Electric Research Laboratories, Inc., 201 Broadway, Cambridge, MA, 02139, US

(21) Appl. No.: 10/624,018

(22) Filed: Jul. 21, 2003

(51) Int. Cl. G06T 15/00

(52) U.S. Cl. 345/419

(57) ABSTRACT

A method provides a virtual reality environment by acquiring multiple videos of an object such as a person at one location with multiple cameras. The videos are reduced to a differential stream of 3D operators and associated operands. These are used to maintain a 3D model of point samples representing the object. The point samples have 3D coordinates and intensity information derived from the videos. The 3D model of the person can then be rendered from any arbitrary point of view at another remote location while acquiring and reducing the video and maintaining the 3D model in real-time.

### FIELD OF THE INVENTION

The present invention relates generally to video processing and rendering, and more particularly to rendering a reconstructed video in real-time.

### BACKGROUND OF THE INVENTION

Over the years, telepresence has become increasingly important in many applications including computer supported collaborative work (CSCW) and entertainment. Solutions for 2D teleconferencing, in combination with CSCW are well known.

However, it has only been in recent years that that 3D video processing has been considered as a means to enhance the degree of immersion and visual realism of telepresence technology. The most comprehensive program dealing with 3D telepresence is the National Tele-Immersion Initiative, Advanced Network & Services, Armonk, N.Y. Such 3D video processing poses a major technical challenge. First, there is the problem of extracting and reconstructing real objects from videos. In addition, there is the problem of how a 3D video stream should be represented for efficient processing and communications. Most prior art 3D video streams are formatted in a way that facilitates off-line post-processing and, hence, have numerous limitations that makes them less practicable for advanced real-time 3D video processing.

Video Acquisition

There is a variety of known methods for reconstructing from 3D video sequences. These can generally be classified as requiring off-line post-processing and real-time methods. The post-processing methods can provide point sampled representations, however, not in real-time.

Spatio-temporal coherence for 3D video processing is used by Vedula et al., “Spatio-temporal view interpolation,” Proceedings of the Thirteenth Eurographics Workshop on Rendering, pp. 65-76, 2002, where a 3D scene flow for spatio-temporal view interpolation is computed, however, not in real-time.

A dynamic surfel sampling representation for estimation 3D motion and dynamic appearance is also known. However, that system uses a volumetric reconstruction for a small working volume, again, not in real-time, see Carceroni et al., “Multi-View scene capture by surfel sampling: From video streams to non-rigid 3D motion, shape & reflectance,” Proceedings of the 7^{th} International Conference on Computer Vision,” pp. 60-67, 2001. Würmlin et al., in “3D video recorder,” Proceedings of Pacific Graphics '02, pp. 325-334, 2002, describe a 3D video recorder which stores a spatio-temporal representation in which users can freely navigate.

In contrast to post-processing methods, real-time methods are much more demanding with regard to computational efficiency. Matusik et al., in “Image-based visual hulls,” Proceedings of SIGGRAPH 2000, pp. 369-374, 2000, describe an image-based 3D acquisition system which calculates the visual hull of an object. That method uses epipolar geometry and outputs a view-dependent representation. Their system neither exploits spatio-temporal coherence, nor is it scalable in the number of cameras, see also Matusik et al., “Polyhedral visual hulls for real-time rendering,” Proceedings of Twelfth Eurographics Workshop on Rendering, pp. 115-125, 2001.

Triangular texture-mapped mesh representation are also known, as well as the use of trinocular stereo depth maps from overlapping triples of cameras, again mesh based techniques tend to have performance limitations, making them unsuitable for real-time applications. Some of these problems can be mitigated by special-purpose graphic hardware for real-time depth estimation.

Video Standards

As of now, no standard for dynamic, free view-point 3D video objects has been defined. The MPEG-4 multiple auxiliary components can encode depth maps and disparity information. However, those are not complete 3D representations, and shortcomings and artifacts due to DCT encoding, unrelated texture motion fields, and depth or disparity motion fields still need to be resolved. If the acquisition of the video is done at a different location than the rendering, then bandwidth limitations are a real concern.

Point Sample Rendering

Although point sampled representations are well known, none can efficiently cope with dynamically changing objects or scenes, see any of the following U.S. Pat. Nos., 6,509,902, Texture filtering for surface elements, 6,498,607, Method for generating graphical object represented as surface elements, 6,480,190, Graphical objects represented as surface elements, 6,448,968, Method for rendering graphical objects represented as surface elements. 6,396,496, Method for modeling graphical objects represented as surface elements, 6,342,886, Method for interactively modeling graphical objects with linked and unlinked surface elements. That work has been extended to include high-quality interactive rendering using splatting and elliptical weighted average filters. Hardware acceleration can be used, but the pre-processing and set-up still limit performance.

Qsplat is a progressive point sample system for representing and displaying a large geometry. Static objects are represented by a multi-resolution hierarchy of point samples based on bounding spheres. As with the surfel system, extensive pre-processing is relied on for splat size and shape estimation, making that method impracticable for real-time applications, see Rusinkiewicz et al., “QSplat: A multi-resolution point rendering system for large meshes,” Proceedings of SIGGRAPH 2000, pp. 343-352, 2000.

Therefore, there still is a need for rendering a sequence of output images derived from input images in real-time.

### SUMMARY OF THE INVENTION

The invention provides a dynamic point sample framework for real-time 3D videos. By generalizing 2D video pixels towards 3D point samples, the invention combines the simplicity of conventional 2D video processing with the power of more complex point sampled representations for 3D video.

Our concept of 3D point samples exploits the spatio-temporal inter-frame coherence of multiple input streams by using a differential update scheme for dynamic point samples. The basic primitives of this scheme are the 3D point samples with attributes such as color, position, and a surface normal vector. The update scheme is expressed in terms of 3D operators derived from the pixels of input images. The operators include an operand of values of the point sample to be updated. The operators and operands essentially reduced the images to a bit stream.

Modifications are performed by operators such as inserts, deletes, and updates. The modifications reflect changes in the input video images. The operators and operands derived from multiple cameras are processed, merged into a 3D video stream and transmitted to a remote site.

The invention also provides a novel concept for camera control, which dynamically selects, from all available cameras, a set of relevant cameras for reconstructing the input video from arbitrary points of view.

Moreover, the method according to the invention dynamically adapts to the video processing load, rendering hardware, and bandwidth constraints. The method is general in that it can work with any real-time 3D reconstruction method, which extracts depth from images. The video rendering method generates 3D videos using an efficient point based splatting scheme. The scheme is compatible with vertex and pixel processing hardware for real-time rendering.

### BRIEF DESCRIPTION OF THE DRAWINGS

FIG. 1 is a block diagram of a system and method for generating output videos from input videos according to the invention;

FIG. 2 is a flow diagram for converting pixels to point samples;

FIG. 3 shows 3D operators;

FIG. 4 shows pixel change assignments;

FIG. 5 is a block diagram of 2D images and corresponding 3D point samples;

FIG. 6 is a schematic of an elliptical splat;

FIG. 7 is a flow diagram of interleaved operators from multiple cameras;

FIG. 8 is a block diagram of a data structure for a point sample operator and associated operand according to the invention; and

FIG. 9 is a graph comparing bit rate for operators used by the invention.

### DETAILED DESCRIPTION OF THE PREFERRED EMBODIMENT

### System Structure

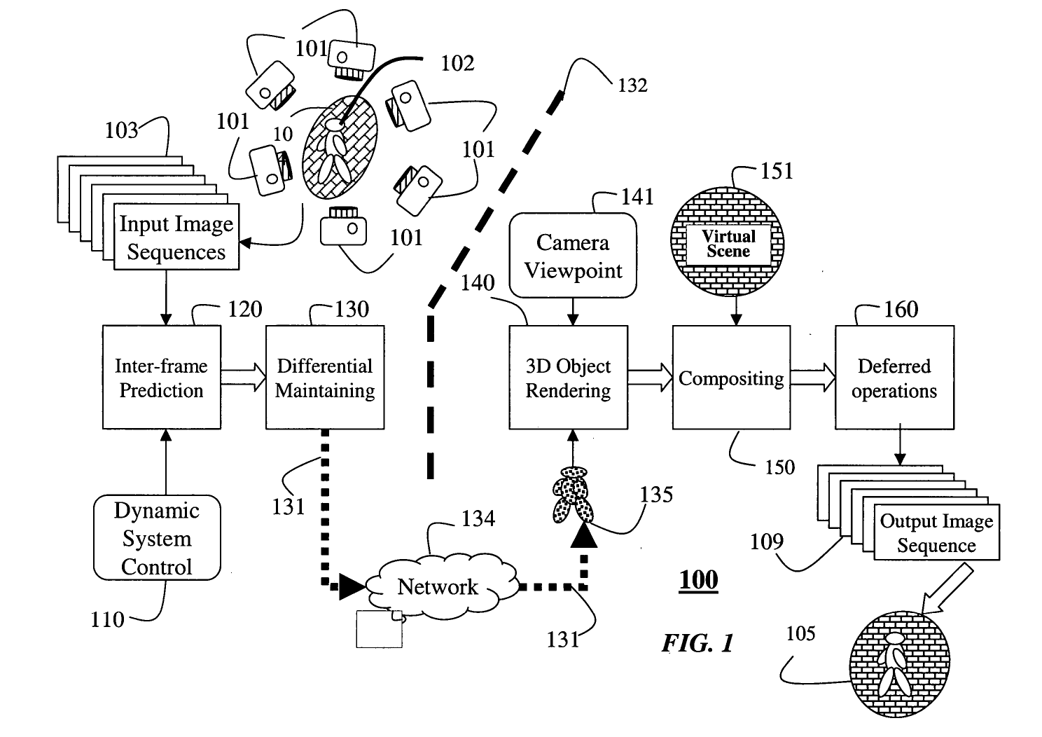

FIG. 1 shows the general structure of a system and method 100 for acquiring input videos 103 and generating output videos 109 from the input videos in real-time according to our invention. As an advantage of our invention, the acquiring can be performed at a local acquisition node, and the generating at a remote reconstruction node, separated in space as indicated by the dashed line 132, with the nodes connected to each other by a network 134.

We used differential 3D streamed data 131, as described below on the network link between the nodes. In essence, the differential stream of data reduces the acquired images to a bare minimum necessary to maintain a 3D model, in real-time, under given processing and bandwidth constraints.

Basically, the differential stream only reflects significant differences in the scene, so that bandwidth, storage, and processing requirements are minimized.

At the local node, multiple calibrated cameras 101 are arranged around an object 102, e.g., a moving user. Each camera acquires an input sequence of images (input video) of the moving object. For example, we can use fifteen cameras around the object, and one or more above. Other configurations are possible. Each camera has a different ‘pose’, i.e., location and orientation, with respect to the object 102.

The data reduction involves the following steps. The sequences of images 103 are processed to segment the foreground object 102 from a background portion in the scene 104. The background portion can be discarded. It should be noted that the object, such as a user, can be moving relative to the cameras. The implication of this is described in greater detail below.

By means of dynamic camera control 110, we select a set of active cameras from all available cameras. This further reduces the number of pixels that are represented in the differential stream 131. These are the cameras that ‘best’ view the user 102 at any one time. Only the images of the active cameras are used to generate 3D point samples. Images of a set of supporting cameras are used to obtain additional data that improves the 3D reconstruction of the output sequence of images 109.

Using inter-frame prediction 120 in image space, we generate a stream 131 of 3D differential operators and operands. The prediction is only concerned with pixels that are new, different, or no longer visible. This is a further reduction of data in the stream 131. The differential stream of 3D point samples is used to dynamically maintain 130 attributes of point samples in a 3D model 135, in real-time. The attributes include 3D position and intensity, and optional colors, normals, and surface reflectance properties of the point samples.

As an advantage of our invention, the point sample model 135 can be at a location remote from the object 102, and the differential stream of operators and operands 131 is transmitted to the remote location via the network 134, with perhaps, uncontrollable bandwidth and latency limitations. Because our stream is differential, we do not have to recompute the entire 3D representation 135 for each image. Instead, we only recompute parts of the model that are different from image to image. This is ideal for VR applications, where the user 102 is remotely located from the VR environment 105 where the output images 109 are produced.

The point samples are rendered 140, perhaps at the remote location, using point splatting and an arbitrary camera viewpoint 141. That is, the viewpoint can be different from those of the cameras 101. The rendered image is composited 150 with a virtual scene 151. In a final stage, we apply 160 deferred rendering operations, e.g., procedural warping, explosions and beaming, using graphics hardware to maximize performance and image quality.

Differential Maintaining Model with 3D Operators

We exploit inter-frame prediction and spatio-temporal inter-frame coherence of multiple input streams and differentially maintain dynamic point samples in the model 135.

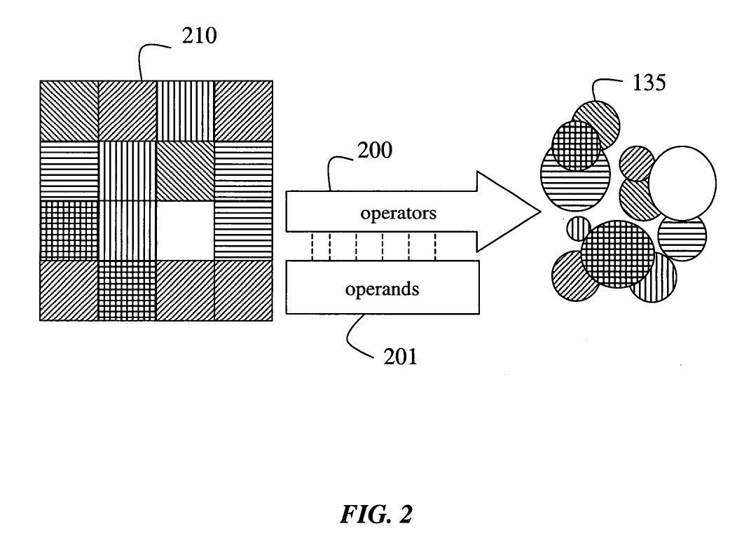

As shown in FIG. 2, basic graphics primitive of our method are 3D operators 200, and their associated operands 201. Our 3D operators are derived from corresponding 2D pixels 210. The operators essentially convert 2D pixels 210 to 3D point samples 135.

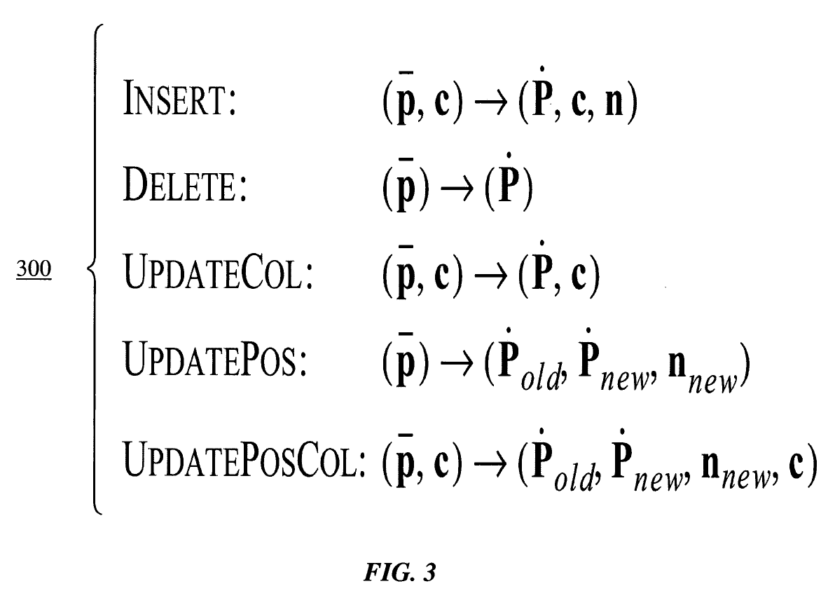

As shown in FIG. 3, we use three different types of operators.

An insert operator adds a new 3D point sample into the representation after it has become visible in one of the input cameras 101. The values of the point sample are specified by the associated operand. Insert operators are streamed in a coarse-to-fine order, as described below.

A delete operator removes a point sample from the representation after it is no longer visible by any camera 101.

An update operator modifies appearance and geometry attributes of point samples that are in the representation, but whose attributes have changed with respect a prior image.

The insert operator results from a reprojection of a pixel with color attributes from image space back into three-dimensional object space. Any real-time 3D reconstruction method, which extracts depth and normals from images can be employed for this purpose.

Note that the point samples have a one-to-one mapping between depth and color samples. The depth values are stored in a depth cache. This accelerates application of the delete operator, which performs a lookup in the depth cache. The update operator is generated for any pixel that was present in a previous image, and has changed in the current image.

There are three types of update operators. An update color operator (UPDATECOL) reflects a color change during inter-frame prediction. An update position (UPDATEPOS) operator corrects geometry changes. It is also possible to update the color and position at the same time (UPDATECOLPOS). The operators are applied on spatially coherent clusters of pixels in image space using the depth cache.

Independent blocks are defined according to a predetermined grid. For a particular resolution, a block has a predetermined number of points, e.g. 16×16, and for each image, new depth values are determined for the four corners of the grid. Other schemes are possible, e.g., randomly select k points. If differences compared to previous depths exceed a predetermined threshold, then we recompute 3D information for the entire block of point samples. Thus, our method provides an efficient solution to the problem of un-correlated texture and depth motion fields. Note that position and color updates can be combined. Our image space inter-frame prediction mechanism 120 derives the 3D operators from the input video sequences 103.

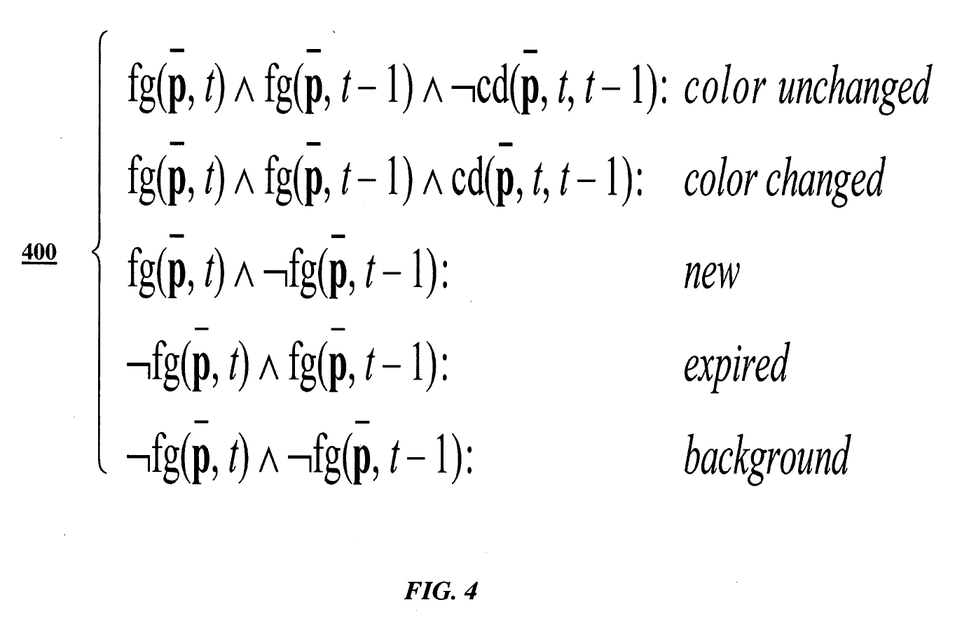

As shown in FIG. 4, we define two Boolean functions for pixel classification. A foreground-background (fg) function returns TRUE when the pixel is in the foreground. A color difference (cd) function returns TRUE if a pixel color difference exceeds a certain threshold between the time instants.

Dynamic System Adaptation

Many real-time 3D video systems use only point-to-point communication. In such cases, the 3D video representation can be optimized for a single viewpoint. Multi-point connections, however, require truly view-independent 3D video. In addition, 3D video systems can suffer from performance bottlenecks at all pipeline stages. Some performance issues can be locally solved, for instance by lowering the input resolution, or by utilizing hierarchical rendering. However, only the combined consideration of application, network and 3D video processing state leads to an effective handling of critical bandwidth and 3D processing bottlenecks.

In the point-to-point setting, the current virtual viewpoint allows optimization of the 3D video computations by confining the set of relevant cameras. As a matter of fact, reducing the number of active cameras or the resolution of the reconstructed 3D video implicitly reduces the required bandwidth of the network. Furthermore, the acquisition frame rate can be adapted dynamically to meet network rate constraints.

Active Camera Control

We use the dynamic system control 110 of active cameras, which allows for smooth transitions between subsets of reference cameras, and efficiently reduces the number of cameras required for 3D reconstruction. Furthermore, the number of so-called texture active cameras enables a smooth transition from a view-dependent to a view-independent rendering for 3D video.

A texture active camera is a camera that applies the intra-frame prediction scheme 120, as described above. Each pixel classified as foreground in images from such a camera contributes color to the set of 3D points samples 135. Additionally, each camera can provide auxiliary information used during the reconstruction.

We call the state of these cameras reconstruction active. Note that a camera can be both texture and reconstruction active. The state of a camera, which does not provide data at all is called, inactive. For a desired viewpoint 141, we select k cameras that are nearest to the on object 102. In order to select the nearest cameras as texture active cameras, we compare the angles of the viewing direction with the angle of all cameras 101.

Selecting the k-closest cameras minimizes artifacts due to occlusions. The selection of reconstruction active cameras is performed for all texture active cameras and is dependent on the 3D reconstruction method. Each reconstruction active camera provides silhouette contours to determine shape. Any type of shape-from-silhouette procedure can be used. Therefore, the set of candidate cameras is selected by two rules. First, the angles between a texture active camera and its corresponding reconstruction active cameras have to be smaller than some predetermined threshold, e.g. 1000. Thus, the candidate set of cameras is confined to cameras lying in approximately the same hemisphere as the viewpoint. Second, the angle between any two cameras is larger than 20°. This reduces the number of almost redundant images that need to be processed. Substantially redundant images provide only marginal different information.

Optionally, we can set a maximum number of candidate cameras as follows. We determined the angle between all candidate camera pairs and discard one camera of the two nearest. This leads to an optimal smooth coverage of silhouettes for every texture active camera. The set of texture active cameras is updated as the viewpoint 141 changes. A mapping between corresponding texture and reconstruction active cameras can be determined during a pre-processing step. The dynamic camera control enables a trade-off between 3D reconstruction performance and the quality of the output video.

Texture Activity Levels

A second strategy for dynamic system adaptation involves the number of reconstructed point samples. For each camera, we define a texture activity level. The texture activity level can reduce the number of pixels processed. Initial levels for k texture active cameras are derived from weight formulas, see Buehler et al., “Unstructured Lumigraph Rendering. SIGGRAPH 2001 Conference Proceedings, ACM Siggraph Annual Conference Series, pp. 425-432, 2001,

$${r}_{i} = \frac{cos {θ}_{i} - cos {θ}_{k + 1}}{1 - cos {θ}_{i}} , {w}_{i} = \frac{{r}_{i}}{{\sum }_{j = 1}^{k} {r}_{j}} ,$$

where rᵢ represent the relative weights of the closest k views, rᵢ is calculated from the cosine of the angles between the desired view and each texture active camera, the normalized weights sum up to one.

The texture activity level allows for smooth transitions between cameras and enforces epipole consistency. In addition, texture activity levels are scaled with a system load penalty penalty_{load} dependent on the load of the reconstruction process. The penalty takes into account not only the current load but also the activity levels of processing prior images. Finally, the resolution of the virtual view is taken into account with a factor ρ leading to the following equation:

$${A}_{i} = {s}_{max} \cdot {w}_{i} \cdot ρ - {penalty}_{load} , with ρ = \frac{{res}_{target}}{{res}_{camera}} ,$$

Note that this equation is reevaluated for each image of each texture active camera. The maximum number of sampling levels sₘₐₓ discretizes Aᵢ to a linear sampling pattern in the camera image, allowing for coarse-to-fine sampling. All negative values of Aᵢ are set to zero.

Dynamic Point Sample Processing and Rendering

We perform point sample processing and rendering of the 3D model 135 in real-time. In particular, a size and shape of splat kernels for high quality rendering are estimated dynamically for each point sample. For that purpose, we provide a new data structure for 3D video rendering.

We organize the point samples for processing on a per camera basis, similar to a depth image. However, instead of storing a depth value per pixel, we store references to respective point attributes.

The point attributes are organized in a vertex array, which can be transferred directly to a graphics memory. With this representation, we combine efficient insert, update and delete operations with efficient processing for rendering.

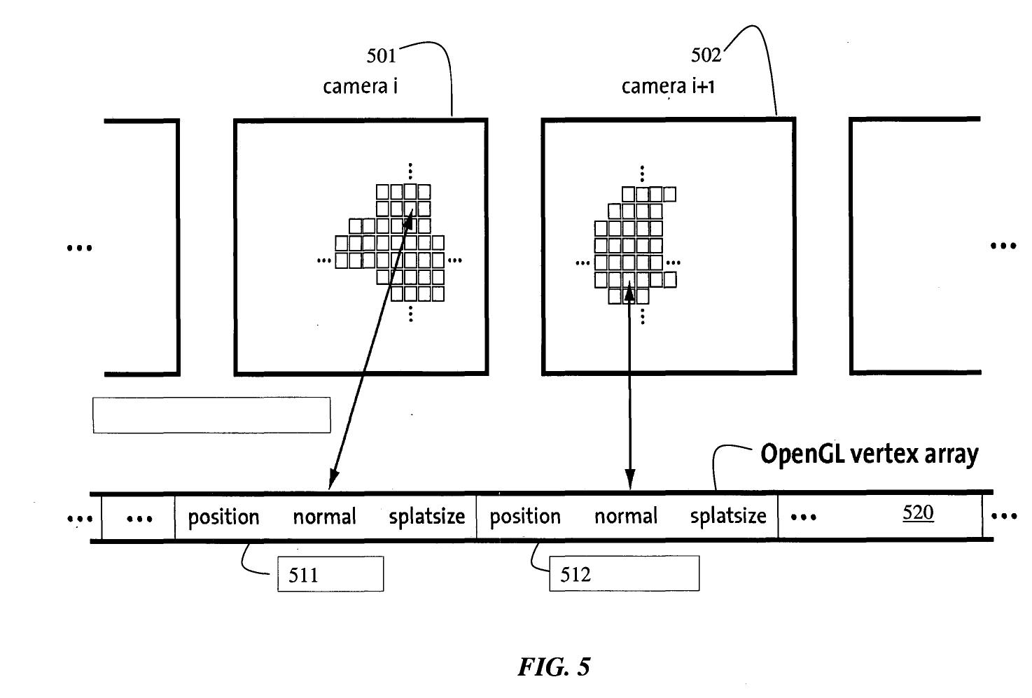

FIG. 5 shows 2D images 501-502 from cameras i and i+1, and corresponding 3D point samples 511-512 in an array 520, e.g., an OpenGL vertex array. Each point sample includes color, position, normal, splat size, and perhaps other attributes.

In addition to the 3D video renderer 140, the compositing 150 combines images with the virtual scene 151 using Z-buffering. We also provide for deferred operations 160, such as 3D visual effects, e.g., warping, explosions and beaming, which are applicable to the real-time 3D video stream, without affecting the consistency of the data structure.

Local Density Estimation

We estimate the local density of point samples based on incremental nearest-neighbor search in the 3D point sample cache. Although the estimated neighbors are only approximations of the real neighbors, they are sufficiently close for estimating the local density of the points samples.

Our estimation, which considers two neighbors, uses the following procedure. First, determine the nearest-neighbor N₁ of a given point sample in the 3D point sample cache. Then, search for a second neighbor N₆₀, forming an angle of at least 60 degrees with the first neighbor. Our neighbor search determines an average of four more neighbors for finding an appropriate N₆₀.

Point Sample Rendering

We render 140 the point samples 135 as polygonal splats with a semi-transparent alpha texture using a two-pass process. During the first pass, opaque polygons are rendered for each point sample, followed by visibility splatting. The second pass renders the splat polygons with an alpha texture. The splats are multiplied with the color of the point sample and accumulated in each pixel. A depth test with the Z-buffer from the first pass resolves visibility issues during rasterization. This ensures correct blending between the splats.

The neighbors N₁ and N₆₀ can be used for determining polygon vertices of our splat in object space. The splat lies in a plane, which is spanned by the coordinates of a point sample p and its normal n. We distinguish between circular and elliptical splat shapes. In the circular case, all side lengths of the polygon are twice the distance to the second neighbor, which corresponds also to the diameter of an enclosing circle.

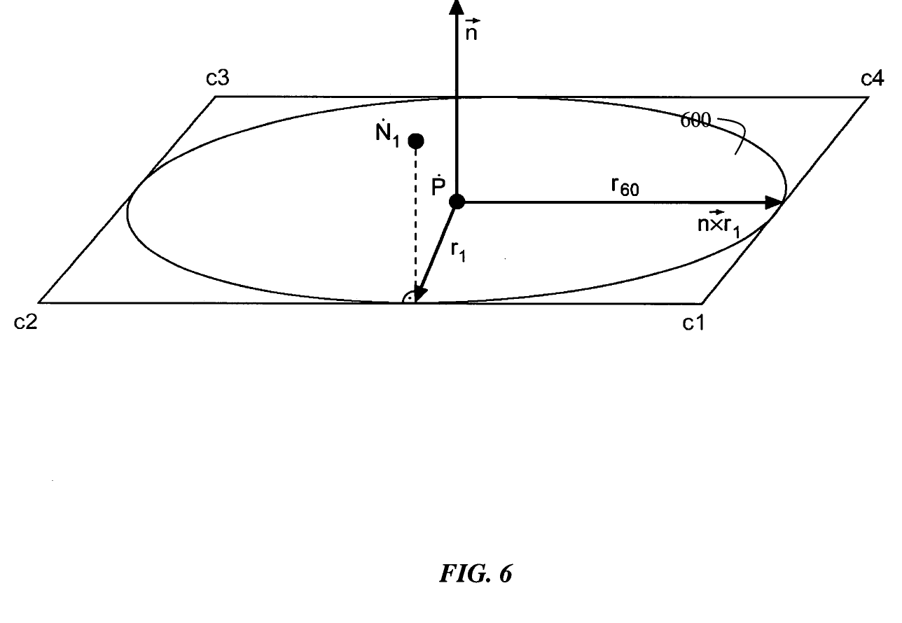

As shown in FIG. 6 for elliptical shapes, we determine the minor axis by projecting the first neighbor onto a tangential plane. The length of the minor axis is determined by the distance to the first neighbor. The major axis is computed as the cross product of the minor axis and the normal. Its length is the distance to N₆₀. For the polygon setup for elliptical splat rendering, r₁ and r₆₀ denote distances from the point sample p to N₁ and N₆₀, respectively, and c₁ to c₄ to denote vertices of the polygon 600.

The alpha texture of the polygon is a discrete unit Gaussian function, stretched and scaled according to the polygon vertices using texture mapping hardware. The vertex positions of the polygon are determined entirely in the programmable vertex processor of a graphics rendering engines.

Deferred Operations

We provide deferred operations 160 on all attributes of the 3D point samples. Because vertex programs only modify the color and position attribute of the point samples during rendering, we maintain the consistency of the representation and of the differential update mechanism.

Implementing temporal effects poses a problem because we do not store intermediate results. This is due to the fact that the 3D operator stream modifies the representation asynchronously. However, we can simulate a large number of visual effects from procedural warping to explosions and beaming. Periodic functions can be employed to devise effects such as ripple, pulsate, or sine waves. In the latter, we displace the point sample along its normal based on the sine to its distance to the origin in object space. For explosions, a point sample's position is modified along its normal according to its velocity. Like all other operation, the deferred operations are performed in real-time, without any pre-processing.

3D Processing

The operation scheduling at the reconstruction (remote) node is organized as follows: The silhouette contour data are processed by a visual hull reconstruction module. The delete and update operations are applied to the corresponding point samples 135. However, the insert operations require a prescribed set of silhouette contours, which is derived from the dynamic system control module 110. Therefore, a silhouette is transmitted in the stream for each image. Furthermore, efficient 3D point sample processing requires that all delete operations from one camera is executed before the insert operations of the same camera. The local acquisition node support this operation order by first transmitting silhouette contour data, then delete operations and update operations, and, finally, insert operations. Note that the insert operations are generated in the order prescribed by the sampling strategy of the input image.

At the remote reconstruction node, an operation scheduler forwards insert operations to the visual hull unit reconstruction module when no other type of data are available. Furthermore, for each camera, active or not, at least one set of silhouette contours is transmitted for every frame. This enables the reconstruction node to check if all cameras are synchronized.

An acknowledgement message of contour data contains new state information for the corresponding acquisition node. The reconstruction node detects a frame switch while receiving silhouette contour data of a new frame. At that point in time, the reconstruction node triggers state computations, i.e., the sets of reconstruction and texture active cameras are predetermined for the following frames.

The 3D operations are transmitted in the same order in which they are generated. A relative ordering of operations from the same camera is guaranteed. This property is sufficient for a consistent 3D data representation.

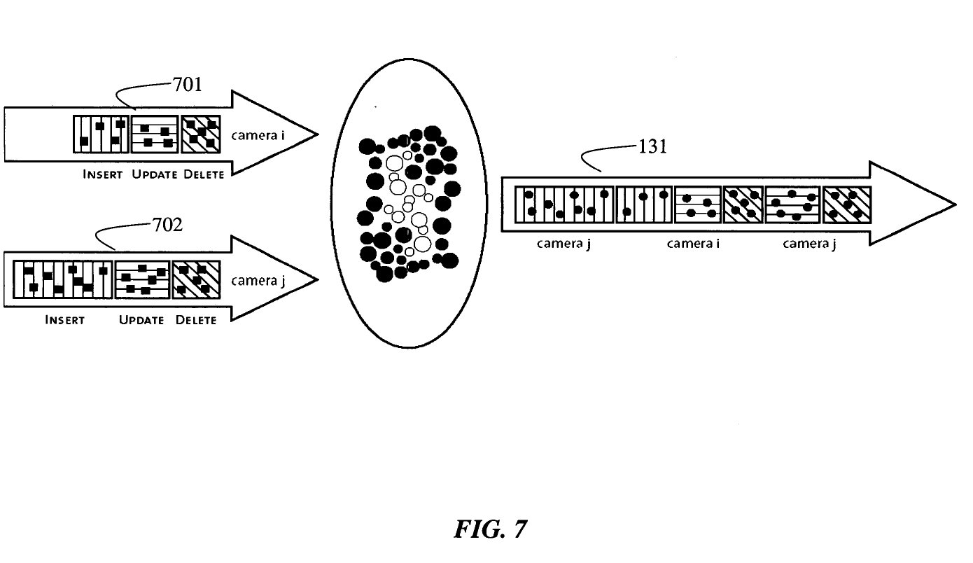

FIG. 7 depicts an example of the differential 3D point sample stream 131 derived from streams 701 and 702 for camera i and camera j.

Streaming and Compression

Because the system requires a distributed consistent data representation, the acquisition node shares a coherent representation of its differentially updated input image with the reconstruction node. The differential updates of the rendering data structure also require a consistent data representation between the acquisition and reconstruction nodes. Hence, the network links use lossless, in-order data transmission.

Thus, we implemented an appropriate scheme for reliable data transmission based on the connectionless and unreliable UDP protocol and on explicit positive and negative acknowledgements. An application with multiple renderers can be implemented by multicasting the differential 3D point sample stream 131, using a similar technique as the reliable multicast protocol (RMP) in the source-ordered reliability level, see Whetten et al., “A high performance totally ordered multicast protocol,” Dagstuhl Seminar on Distributed Systems, pp. 33-57, 1994. The implementation of our communication layer is based on the well-known TAO/ACE framework.

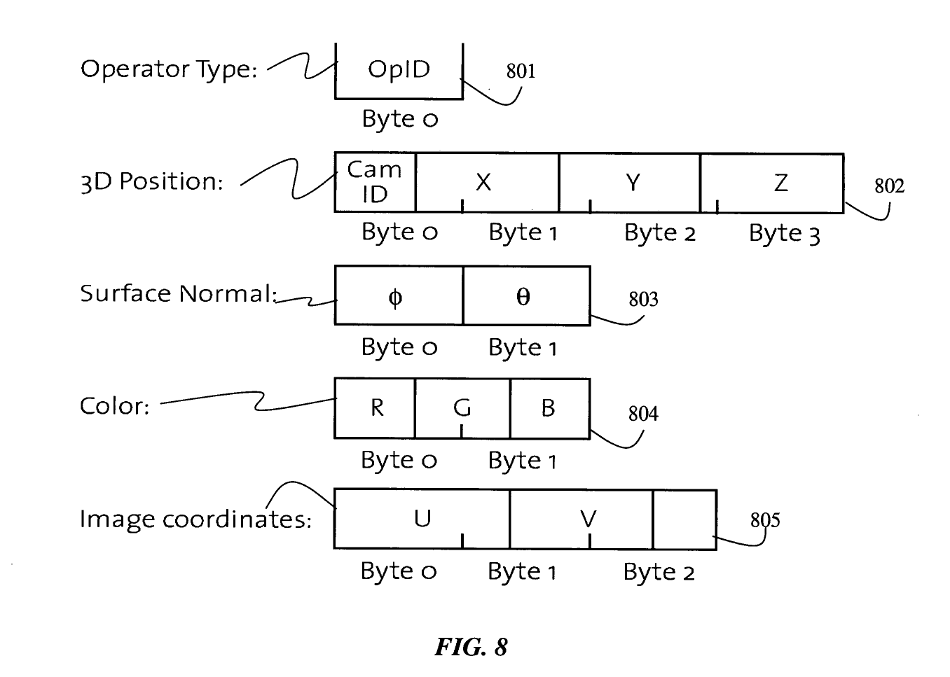

FIG. 8 shows the byte layout for attributes of a 3D operator, including operator type 801, 3D point sample position 802, surface normal 803, color 804, and image location 805 of the pixel corresponding to the point sample.

A 3D point sample is defined by a position, a surface normal vector and a color. For splat footprint estimation issues, the renderer 140 needs a camera identifier and the image coordinates 805 of the original 2D pixel. The geometry reconstruction is done with floating-point precision. The resulting 3D position can be quantized accurately using 27 bits. This position-encoding scheme at the acquisition node leads to a spatial resolution of approximately 6×4×6 mm³. The remaining 5 bits of a 4-byte word can be used to encode the camera identifier (CamID). We encode the surface normal vector by quantizing the two angles describing the spherical coordinates of a unit length vector. We implemented a real-time surface normal encoder, which does not require any real-time trigonometric computations.

Colors are encoded in RGB 5:6:5 format. At the reconstruction node, color information and 2D pixel coordinates are simply copied into the corresponding 3D point sample. Because all 3D operators are transmitted over the same communication channel, we encode the operation type explicitly. For update and delete operations, it is necessary to reference the corresponding 3D point sample. We exploit the feature that the combination of quantized position and camera identifier references every single primitive.

The renderer 140 maintains the 3D point samples in a hash table. Thus, each primitive can be accessed efficiently by its hash key.

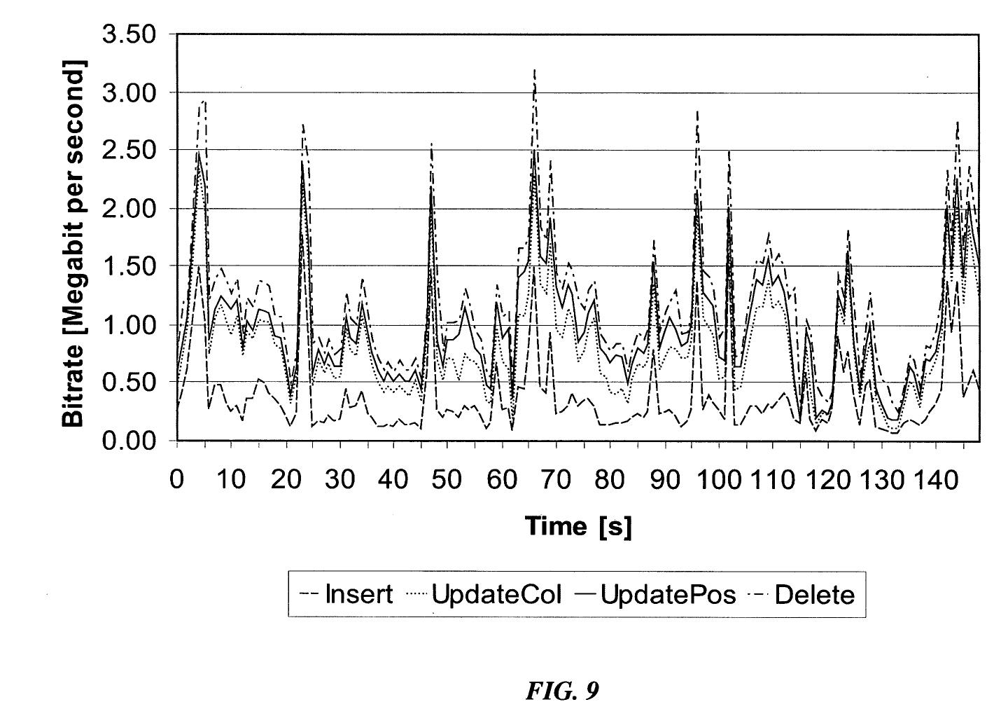

FIG. 9 shows the bandwidth or cumulative bit rate required by a typical sequence of differential 3D video, generated from five contour active and three texture active cameras at five frames per second. The average bandwidth in this sample sequence is 1.2 megabit per second. The bandwidth is strongly correlated to the movements of the reconstructed object and to the changes of active cameras, which are related to the changes of the virtual viewpoint. The peaks in the sequence are mainly due to switches between active cameras. It can be seen that the insert and update color operators consume the largest part of the bit rate.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

1. A method for providing a virtual reality environment, comprising:
acquiring concurrently, with a plurality of cameras, a plurality of sequences of input images of a 3D object, each camera having a different pose;
reducing the plurality of sequences of images to a differential stream of 3D operators and associated operands;
maintaining a 3D model of point samples representing the 3D object from the differential stream, in which each point sample of the 3D model has 3D coordinates and intensity information;
rendering the 3D model as a sequence of output image of the 3D object from an arbitrary point of view while acquiring and reducing the plurality of sequences of images and maintaining the 3D model in real-time.

2. The method of claim 1, in which the acquiring and reducing are performed at a first node, and the rendering and maintaining are performed at a second node, and further comprising:
transmitting the differential stream from the first node to the second node by a network.

3. The method of claim 1, in which the object is moving with respect to the plurality of cameras.

4. The method of claim 1, in which the reducing further comprises:
segmenting the object from a background portion in a scene; and
discarding the background portion.

5. The method of claim 1, in which the reducing further comprises:
selecting, at any one time, a set of active cameras from the plurality of cameras.

6. The method of claim 1, in which the differential stream of 3D operators and associated operands reflect changes in the plurality of sequences of images.

7. The method of claim 1, in which the operators include insert, delete, and update operators.

8. The method of claim 1, in which the associated operand includes a 3D position and color as attributes of the corresponding point sample.

9. The method of claim 1, in which the point samples are rendered with point splatting.

10. The method of claim 1, in which the point samples are maintained on a per camera basis.

11. The method of claim 1, in which the rendering combines the sequence of output images with a virtual scene.

12. The method of claim 1, further comprising:
estimating a local density for each point sample.

13. The method of claim 1, in which the point samples are rendered as polygons.

14. The method of claim 1, further comprising:
sending a silhouette image corresponding to a contour of the 3D object in the differential stream for each reduced image.

15. The method of claim 1, in which the differential stream is compressed.

16. The method of claim 1, in which the associated operand includes a normal of the corresponding point sample.

17. The method of claim 1, in which the associated operand includes reflectance properties of the corresponding point sample.

18. The method of claim 1, in which pixels of each image are classified as either foreground or background pixels, and in which only foreground pixels are reduced to the differential stream.

19. The method of claim 1, in which attributes are assigned to each point samples, and the attributes are altered while rendering.

20. The method of claim 19, in which the point attributes are organized in a vertex array that is transferred to a graphics memory during the rendering.
